(19) United States
(12) Patent Application Publication
(10) Pub. No.: US 2005/0061523 A1
(43) Pub. Date: Mar. 24, 2005

(54) Hand machine tool

(76) Inventors: Richard Bader, Kuenzelsau (DE); Johann Buss, Gerlingen (DE)

Correspondence Address: STRIKER, STRIKER & STENBY, 103 EAST NECK ROAD, HUNTINGTON, NY, 11743, US

(21) Appl. No.: 10/945,070

(22) Filed: Sep. 20, 2004

(30) Foreign Application Priority Data
Sep. 22, 2003 (DE) 103 44 164.6

(51) Int. Cl. B25D 17/24

(52) U.S. Cl. 173/216; 173/162.1

(57) ABSTRACT

An angular hand power tool has a longitudinal part, a driven part arranged at an end of the longitudinal part substantially transversely to the latter, an angle transmission with a housing, connecting the driven part and the longitudinal part with one another, so that the transmission and the housing together form an angle head, the longitudinal part being provided with a gripping region, and a plastic element provided in a gripping region and covering the angle head, the covering element having a shape, a surface and a material selected so as to form a second integral handle which can be reliably gripped.

### BACKGROUND OF THE INVENTION

The present invention relates to angular hand machine tools.

More particularly, it relates to angular hand machine tools which have a longitudinal part, and an abrasive part arranged substantially perpendicularly at an end of the elongated part, wherein both parts are connected by an angular transmission with the housing composed of metal.

Angular hand devices are used in all areas of industry, for screwing, drilling, grinding, etc. The device as a rule includes a longitudinal part and an abrasive part which is arranged on the longitudinal part, as shown in FIG. 1. The driven shaft 100 and the longitudinal part or the device part 105 are connected by an angle transmission including a metal housing, so as to form together a so-called angular head 101. The main function of the transmission is the deviation of the driven shaft of the device, or in other words purely functional.

This deviation is intended, in addition to other purposes, to simplify the use of the device by the user. The device which is designed in this manner can be held stable, when compared with a straight device without an angular transmission. The transmission is considered as a purely functional deviating part and for this reason has a stable and inexpensive metal housing.

Such devices as a rule are guided with two hands because of their weight and because of the reaction moment generated during screwing/drilling. The user must firmly hold the device with two hands to provide stability of guidance of the device. For this purpose he grasps the longitudinal part 103 with his second hand, or grips a frequently available second handle 102 arranged perpendicular to the driven and longitudinal part. Existing angular devices, in particular devices which are guided with two hands, are difficult to guide and to use because of the device geometry.

### SUMMARY OF THE INVENTION

Accordingly, it is an object of the present invention to provide an angular hand power tool, which avoids the disadvantages of the prior art.

More particularly, it is an object of the present invention to provide an angular hand power tool which eliminates the geometry-related disadvantages of the existing devices with respect to the second handle.

In keeping with these objects and with others which will become apparent hereinafter, one feature of the present invention resides, briefly stated, in an angular hand power tool, comprising a longitudinal part; a driven part arranged at an end of said longitudinal part substantially transversely to the latter; an angle transmission with a housing, connecting said driven part and said longitudinal part with one another, so that said transmission and said housing together form an angle head, said longitudinal part being provided with a gripping region; and a plastic element provided in a gripping region and covering said angle head, said covering element having a shape, a surface and a material selected so as to form a second integral handle which can be reliably gripped.

When the hand power tool is designed in accordance with the present invention, it can be optimally guided without a second handle arranged perpendicular to the driven and longitudinal part.

In the inventive hand power tool the housing which is composed of metal, or a similar material, or another corresponding material and connects the both parts, namely the driven part and the elongated part, with one another, is covered with synthetic plastic material up to the driven shaft, in particular by the injection molding. The shape, surface and the material of the synthetic plastic covering is selected so that a gripping-reliable, second integral handle is provided.

The covered housing, in contrast to the metal housing, is conveniently held in hand and can be guided in the hand without fatigue or pressure points. The user can apply a pressure along the rotary axis of the device for guiding the working process in optimal manner.

Preferably, the integral handle is always positioned directly above the working point of the workpiece. The hand tool device can be stabilized and guided with the second integral handle, without generating a mechanical tilting moment and without negatively affecting the working process, such as drilling or screwing. The integral handle provided in this way has also the mechanical advantage in that the reaction moment which is generated during the acceleration of the driven shaft can be taken by the user in optimal way.

In accordance with a further embodiment of the present invention, the surface of the synthetic plastic can be provided with depressions or structures, that allow a convenient and also stabilizing gripping of the device for the user.

In accordance with a further advantageous embodiment of the present invention the used synthetic plastic material has vibration-absorbing properties. The handling of the device is considerably facilitated due to the low-vibration integral handle, since the hands of the user are not fatigued by the vibrations.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a principle diagram of an angular hand power tool in accordance with the prior art; and

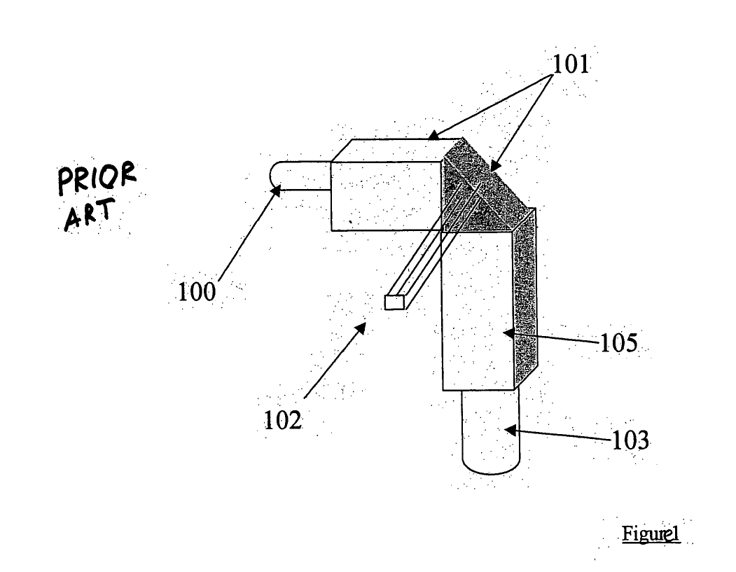

FIG. 2 is a view showing an angular and power tool in accordance with the present invention.

### DESCRIPTION OF THE PREFERRED EMBODIMENTS

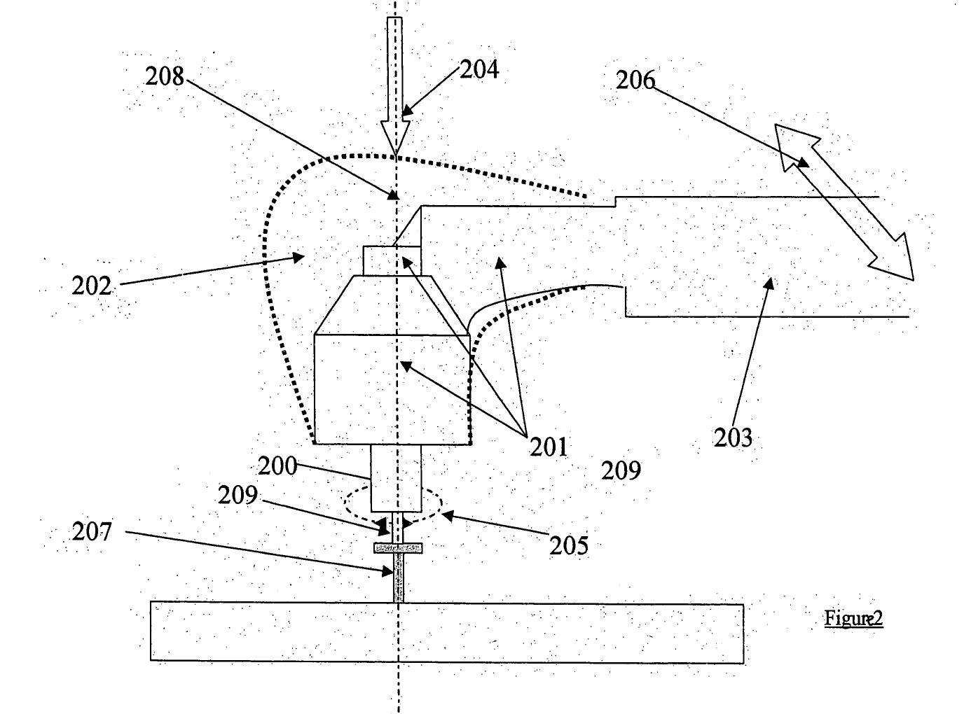

FIG. 2 shows a hand power tool in accordance with the present invention, in a side view. The device substantially includes a longitudinal part 203 forming a device body, an angular transmission housing or an angular head 201, and a driven shaft 200. The longitudinal part can be composed of steel or a similar mechanically stabile material. Preferably, it is provided with a synthetic plastic coating and in operation used as a main handle.

The synthetic plastic coating can be composed for example of ethylene vinyl acetate.

An angle transmission is accommodated in the end of the longitudinal part 203 for mechanically changing the driving direction by 90°. The transmission is composed of a simple metal housing 201 which connects the both parts with one another and mechanically supports the driven shaft 200.

The device shown in FIG. 2 is a screwing device. For providing a positive (form-locking) connection with a screw 27 and applying a desired torque, a tool, such as for example a screw turning insert 209 which corresponds to a workpiece or screw 207 is arranged on the driven shaft 200. During the screwing process, the rotation 205 of the driven shaft 200 and of the screwing insert 207 applies a torque to the screw 207 for turning the screw 207.

For screwing the screw 207 in fast and efficient manner, not only a torque, but also an axial pressing force 204 must be applied to the screw 207. A pressing force vector must act in an axial direction 208 toward the longitudinal axis of the screw 207, to avoid a tilting moment. The pressing force 204 is applied by a device user, in that he grasps with his one hand on the synthetic plastic coating 202 of the device, or in other words on the integral handle, and presses it in the direction 204.

When despite the ideal introduction action on the integral handle 202 a tilting moment must be available, the effect of the tilting moment is minimized, since the distance between the upper surface of the coating 202 and the driven point or the point of rotation 205 acting as a lever is very short.

FIG. 2 also schematically shows a direction of a reaction moment of the device produced by the acceleration of the driven shaft 200. The reaction moment 206, that acts as a moment around the driven axis 208, is produced by the acceleration of the drive shaft 200 and must be taken by the device user. The user can take the moment 206 in an optimal way, since it can apply a device-stabilized pressure with one hand directly along the rotary axis 208 of the device, and can apply with his second hand a moment which counteracts the reaction moment.

The inventive synthetic plastic coating of the angular head of the hand device does not provide only advantageous with respect to the design, but it provides an ergonomical and technical improvement of the device. The above mentioned technical advantages made possible a simpler and more accurate and comfortable guidance of the device and thereby an increased productivity. It is also clear that the device can be designed as an integral handle and can be produced as a unit so that the shape and the material of the housing satisfy the requirements to a handle without a coating.

It will be understood that each of the elements described above, or two or more together, may also find a useful application in other types of constructions differing from the types described above.

While the invention has been illustrated and described as embodied in a hand machine tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An angular hand power tool, comprising a longitudinal part; a driven part arranged at an end of said longitudinal part substantially transversely to the latter; an angle transmission with a housing, connecting said driven part and said longitudinal part with one another, so that said transmission and said housing together form an angle head, said longitudinal part being provided with a gripping region; and a plastic element provided in a gripping region and covering said angle head, said covering element having a shape, a surface and a material selected so as to form a second integral handle which can be reliably gripped.

2. An angular hand power tool as defined in claim 1, wherein said second integral handle is spaced from said gripping region on said longitudinal part by a distance which is selected so that reaction forces or moments generated by driving of the hand power tool are reliably compensatable by sufficient movement flexibility of a user in operational conditions.

3. An angular hand power tool as defined in claim 1, wherein said plastic coating element has a surface provided with gripping depressions.

4. An angular hand power tool as defined in claim 1, wherein said plastic coating element has a surface provided with gripping troughs.

5. An angular hand power tool as defined in claim 1, wherein said plastic coating element has a surface provided with gripping structures.

6. An angular hand power tool as defined in claim 1, wherein said plastic coating element is composed of a vibration-absorbing material.

7. An angular hand power tool as defined in claim 1, wherein said plastic coating element is composed of a vibration-dampening material.

8. An angular hand power tool as defined in claim 1, wherein said plastic coating element is composed of ethylene vinyl acetate.

9. An angular hand power tool as defined in claim 1, wherein said plastic coating element is formed as an injection molded plastic coating element on said angle head.
